(19) United States
(12) Patent Application Publication
(10) Pub. No.: US 2011/0177809 A1
(43) Pub. Date: Jul. 21, 2011

(54) AFFECTING A NAVIGATION FUNCTION IN RESPONSE TO A PERCEIVED TRANSITION FROM ONE ENVIRONMENT TO ANOTHER

(75) Inventors: Payam Pakzad, Mountain View, CA (US); Alok Aggarwal, Foster City, CA (US); Ayman Fawzy Naguib, Santa Clara, CA (US)

(73) Assignee: QUALCOMM Incorporated, San Diego, CA (US)

(21) Appl. No.: 12/969,988

(22) Filed: Dec. 16, 2010

Related U.S. Application Data
(60) Provisional application No. 61/295,509, filed on Jan. 15, 2010.

(51) Int. Cl. H04W 24/00

(52) U.S. Cl. 455/423; 455/456.1

(57) ABSTRACT

Techniques are provided that may be implemented in various methods and apparatuses to allow an electronic device to determine when it is transitioning or has transitioned from a first environment to a second environment based, at least in part, on at least one measured parameter. The measured parameter may be based, at least in part, on one or more received wireless signals associated with one or more wireless signal transmitters, and/or one or more signals associated with one or more non-radio sensors. The electronic device may then affect operation of a navigation function (e.g., having a trajectory estimation filter) based, at least in part, on the measured parameter.

### CROSS REFERENCE TO RELATED APPLICATION

This application claims priority to U.S. Provisional Patent Application Ser. No. 61/295,509, filed Jan. 15, 2010, entitled “Adaptive Parameter Tuning Based on Signal Characteristics,” which is hereby incorporated by reference in its entirety.

### BACKGROUND

1. Field

The subject matter disclosed herein relates to electronic devices, and more particularly to methods and apparatuses for use in and/or with an electronic device to support position/navigation estimation determination in a wireless operating space having different perceivable (detectable) environments.

2. Information

It is often useful to determine a position of an electronic device with reference to some location scheme. For example, some electronic devices may include a global positioning system (GPS) and/or other like global navigation satellite system (GNSS) receiver that is capable of determining a relative geographical location of the electronic device using an applicable positioning function. For example, some electronic devices, e.g., a mobile station, may be capable of estimating on its own, its relative location based on wireless signals received from a GNSS, or possibly with network support with additional positioning information provided via wireless signal transmitters (e.g. base stations, access points, location beacons, etc.).

There may, however, be situations wherein an electronic device for various reasons may be unable to receive the requisite wireless signals to support a given positioning function. Thus, an electronic device may move to a location wherein the requisite wireless signal transmissions are no longer available for use, e.g., in which wireless signals from a GNSS and/or other like network supported information may be substantially attenuated and/or otherwise affected some manner which precludes their use.

It may be beneficial for an electronic device to determine when certain environment transitions occur and to respond in some manner thereto such that position estimation may continue in some manner.

### SUMMARY

In accordance with an example implementation, a method is provided with comprises, with an electronic device: determining that the electronic device is transitioning or has transitioned from a first environment to a second environment based, at least in part, on at least one measured parameter, the at least one measured parameter being based, at least in part, on at least one of: one or more received wireless signals associated with one or more wireless signal transmitters, and/or one or more signals associated with one or more non-radio sensors; and in response to a determination that the electronic device is transitioning or has transitioned from the first environment to the second environment, affecting operation of a trajectory estimation filter of a navigation function based, at least in part, on the at least one measured parameter.

In accordance with another example implementation, an apparatus for is provided for use in an electronic device. The apparatus comprising: at least one of: one or more radio receivers to receive one or more wireless signals associated with one or more wireless signal transmitters, and/or one or more non-radio sensors; and at least one processing unit to: perform a navigation function using a trajectory estimation filter; determine that the electronic device is transitioning or has transitioned from a first environment to a second environment based, at least in part, on at least one measured parameter, the at least one measured parameter being based, at least in part, on at least one of: one or more received wireless signals associated with the one or more wireless signal transmitters, and/or one or more signals associated with the one or more non-radio sensors; and in response to a determination that the electronic device is transitioning or has transitioned from the first environment to the second environment, affect operation of the trajectory estimation filter based, at least in part, on the at least one measured parameter.

In accordance with another example implementation, an article of manufacture is provided which comprises a computer readable storage medium having stored thereon computer implementable instructions executable by one or more processing units of an electronic device to: determine that the electronic device is transitioning or has transitioned from a first environment to a second environment based, at least in part, on at least one measured parameter, the at least one measured parameter being based, at least in part, on at least one of: one or more received wireless signals associated with one or more wireless signal transmitters, and/or one or more signals associated with one or more non-radio sensors; and in response to a determination that the electronic device is transitioning or has transitioned from the first environment to the second environment, affect operation of a trajectory estimation filter of a navigation function based, at least in part, on the at least one measured parameter.

In accordance with yet another example implementation, an apparatus if provided for use in an electronic device. The apparatus comprises: means for providing a navigation function that uses a trajectory estimation filter; means for determining that said electronic device is transitioning or has transitioned from a first environment to a second environment based, at least in part, on at least one measured parameter, the at least one measured parameter being based, at least in part, on at least one of: one or more received wireless signals associated with one or more wireless signal transmitters, and/or one or more signals associated with one or more non-radio sensors; and means for affecting operation of the trajectory estimation filter based, at least in part, on the at least one measured parameter, in response to a determination that the electronic device is transitioning or has transitioned from the first environment to the second environment.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1 is a schematic block diagram illustrating an electronic device within a wireless operating space having a navigation function that may be affected in some manner for use in different detectable environments, in accordance with an implementation.

FIG. 2 is a schematic block diagram illustrating certain information that may be stored and/or otherwise used in an example electronic device within a wireless operating space having a navigation function that may be affected in some manner for use in different detectable environments, in accordance with an implementation.

FIG. 3 is a functional flow-diagram illustrating certain features of an example process that may be implemented in an example electronic device within a wireless operating space having a navigation function that may be affected in some manner for use in different detectable environments, in accordance with an implementation.

### DETAILED DESCRIPTION

In accordance with certain aspects of the present description, various techniques are provided which may be implemented in an electronic device to allow the device to estimate its current position. More specifically, such an electronic device may comprise a navigation function that may be affected in some manner for use in different detectable environments.

By way of example, techniques are provided which may be implemented in various methods and apparatuses to allow an electronic device to determine when it is transitioning or has transitioned (e.g., via user movement) between certain environments which may be perceived (detected), for example, from observations associated with wireless signals and/or information obtained (detected) from non-radio sensors. The wireless signals may, for example, be associated with a wireless communication network and an environment transition determination may be based, at least in part, on one or more measured signal parameters associated with such wireless signals. The information from non-radio sensors may, for example, be associated with a perceived movement as detected by one or more inertial sensor(s) (e.g., an accelerometer, a gyroscope, etc.), one or more magnetometers or the like, a barometer, a thermometer, one or more light sensors or the like and/or a camera, a microphone or the like, and/or other like non-radio sensors.

In response to an environment transition determination, the techniques may further allow for one or more positioning functions (e.g., a navigation function comprising a trajectory estimation filter) to be operatively affected in some manner. For example, a trajectory estimation filter may be adapted in some way to better operate in a perceived environment.

In accordance with certain example implementations, an apparatus may be provided for use in and/or as an electronic device, such as, for example, a portable electronic computing and/or communication device, a portable navigation device, and/or the like. Here, for example, such apparatus may comprise various forms of hardware, firmware, and/or a combination of hardware and/or firmware and computer implementable instructions executable thereby. In certain example devices, all or portions of such an apparatus and/or its related processing/functionality may be implemented in one or more integrated circuits.

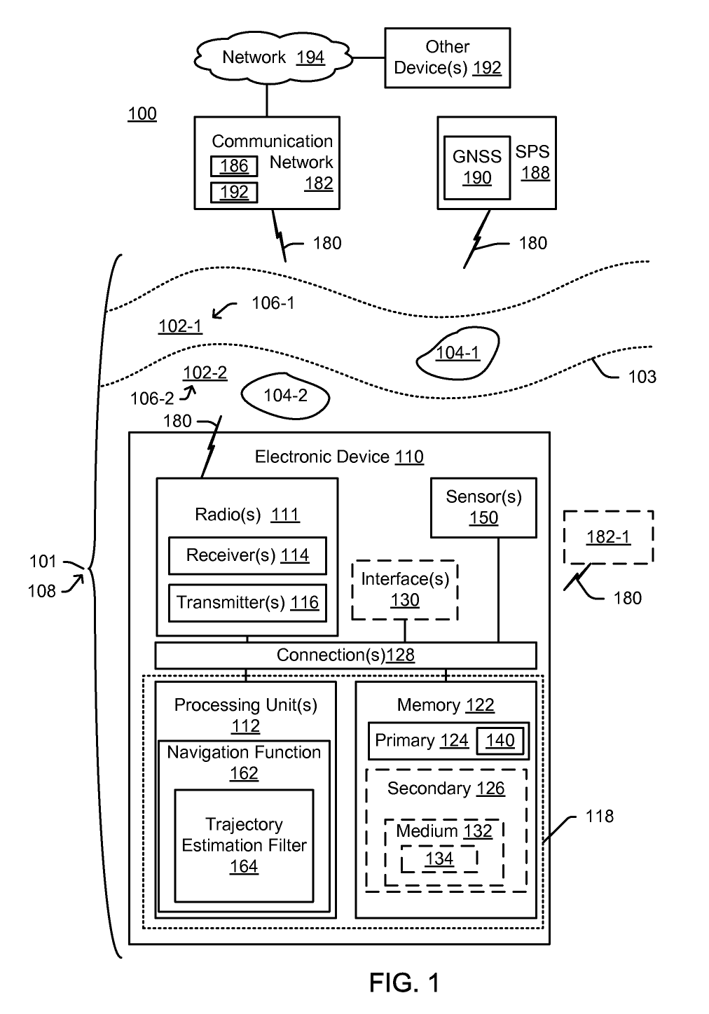

FIG. 1 is a block diagram schematically illustrating certain aspects of an example wireless operating space 100 presenting a plurality of different “environments” 102 within which an electronic device 110 may be located or may become located. Here, for example, a first environment 102-1 and a second environment 102-2 are illustrated as being adjacent to one another along a boundary region 103. Although illustrated as being separated at about boundary region 103, it should be understood that in certain implementations, for example, two or more “environments” may overlap in some manner and/or one or more “environments” may comprise one or more other “environments (e.g., a nested configuration).

Although illustrated as a finite point in space, it should be understood that in certain instances, boundary region 103 may take the form of a region of space wherein two or more environments overlap in some manner. Thus, certain boundary regions may themselves extend for some distance and may comprise one or more identifiable “environments”.

As used herein, the term “environment” refers to at least one region that is at least partially within at least one wireless operating space 100 and which may be at least perceived to be operatively different from at least one other “environment”. Such operative differences may, for example, be determined based, at least in part, on one or more measured signal parameters associated with one or more wireless signals received by an electronic device. For example, electronic device 110 may identify one or more environments as it is carried by a user entering into, exiting from, and/or otherwise being located within a given region.

By way of example but not limitation, certain environments may comprise different wireless signal transmitters and/or otherwise present various static/dynamic physical features 104, which in some manner affect wireless signal transmissions and/or may relate in some manner to certain operative contexts. For example, one or more physical features 104-1 may affect in some manner one or more wireless signals 180 that may be received (and possibly transmitted) by an electronic device within environment 102-1. For example, one or more physical features 104-2 may affect in some manner one or more wireless signals 180 that may be received (and possibly transmitted) by an electronic device within environment 102-2. Physical features 104 may, for example, include any natural land formations, various fauna, and/or man-made structures, objects, etc., that may in some manner act to affect wireless signal transmissions.

Physical features 104 may, for example, also be associated with and/or relate in some manner to certain operative contexts. For example, an operative context may identify a farm property, a valley, a city, a building, a campus, an arena, a park, a library, a warehouse, a zoo, a hospital, a shopping mall, a maritime channel/port, etc., for which certain positioning/navigation information and/or associated positioning function(s) may be available for use by an electronic device.

Within an indoor context, physical features 104 may, for example include walls, doors, cubicles and permanent partitions, furniture, windows, and any other objects and obstacles that in some manner affect wireless signal properties.

As electronic device 110 is moved from one environment to another environment it may be beneficial to determine that such a transition is occurring, or has occurred and in response to such an environment transition determination possibly affect the operation of a positioning function in some manner. For example, operation of a navigation function may be affected in some manner for improved use in an environment as exists and/or as perceived to exist.

Several techniques are provided herein that, for example, illustrate how an electronic device 110 may independently (or alternatively with some assistance from one or more other devices) determine a transition from first environment 102-1 to second environment 102-2 based, at least in part, on one or more measured parameters 140 associated with wireless signals 180 transmitted by wireless communication network(s) 182 and/or one or more other wireless transmitters, and/or one or more signals associated with one or more non-radio sensors 150. Electronic device 110 may, for example, in response to a determination that electronic device is transitioning or has transitioned from a first environment to a second environment, affect operation of a trajectory estimation filter 164 of a navigation function 160 based, at least in part, on at least one measured parameters 140. By way of non-limiting example, a measured parameter 140 may be associated with an operative parameter affecting operation of trajectory estimation filter 164. Hence, by changing such an operative parameter, the operation of trajectory estimation filter 164 may be affected (e.g., for use in an environment as exists and/or as perceived to exist).

For example, in certain situations, first environment 102-1 may take the form of an outdoor environment and second environment 102-2 may take the form of an indoor environment. In other example situations, first environment 102-1 may take the form of a more rural environment and second environment 102-2 may take the form of a more urban environment.

In still other examples, first environment 102-1 may take the form of a relatively non-occluded environment while second environment 102-2 may take the form of a more occluded environment with regard to wireless signaling. In certain example situations, first environment 102-1 may take the form of a less (RF) noisy environment (e.g., non-noisy) and second environment 102-2 may take the form of a relatively more noisy environment. For example, in certain situations, first environment 102-1 may take the form of a relatively more reliable signaling environment while second environment 102-2 may take the form of a less reliable signaling environment (e.g., non-reliable).

In a further illustrated example, as shown in FIG. 1, the first and second environments may represent different indoor spaces 106-1 and 106-2, e.g., located within a common physical structure 108 and/or the like. For example, indoor spaces 106-1 and 106-2 may include different floors, sections, wings, and/or the like associated with an office building.

It should be recognized that in certain instances a transition from one environment to another environment may occur rather abruptly and quickly depending upon the differences in the environments and/or the movement related aspects. For example, there may be an abrupt transition when an electronic device is carried into a space that is shielded from external RF signals. Here, for example, there may be distinct

In other instances, a transition may be more subtle and/or drawn out. For example, as mentioned, a boundary region 103 and/or other like overlapping regions may present a plurality of identifiable environments during a transition period. Thus, a plurality of “small” environments may be identified in based on measured signal parameters associated with wireless signals received by an electronic device as it moves within a boundary region.

As illustrated in the example of FIG. 1, electronic device 110 may comprise one or more radios 111 shown here as possibly comprising one or more receivers 114 and/or transmitters 116. Of course, a radio may comprise a transceiver as well. One or more radios 111 may, for example, be provided to receive wireless signals 180 transmitted by communication network 182, a Satellite Positioning System (SPS) 188 (e.g., a Global Navigation Satellite System (GNSS)) and/or the like. One or more radios 111 may be provided to transmit wireless signals 180, for example to one or more other electronic devices 192 associated with communication network 182 and/or otherwise accessible there through, e.g., via a further network 194, and/or the like.

Also, as shown in this example, communication network 182 may include one or more terrestrial-based wireless signal transmitters 186. For example, a communication network 182 may take the form of a cellular network having one or more terrestrial-based wireless signal transmitters 186 that act as base transceiver stations or the like, repeater devices (e.g., providing so-called Fempto-cell, Pico-cell, etc., service coverage), and/or the like.

In other examples, a communication network 182 may take the form of a wireless wide area network or the like, having one or more terrestrial-based wireless signal transmitters 186 that act as access points, and/or the like. In certain examples, a communication network 182 may provide certain positioning services, which may operate independently and/or along with (e.g., augmenting) all or part of SPS 188, a GNSS 190, and/or the like.

Radios 111 may, for example, be capable of supporting one or more computing and communication services, such as, for example, telecommunication services, location/navigation services, and/or other like information and/or services with regard to electronic device 110.

In certain example implementations, electronic device 110 may include a portable electronic device such as a mobile station, e.g., a cellular phone, a smart phone, a personal digital assistant, a portable computing device, a navigation unit, and/or the like or any combination thereof. In other example implementations, electronic device 110 may take the form of one or more integrated circuits, circuit boards, and/or the like that may be operatively enabled for use in another device.

With such examples and others in mind, electronic device 110 may, for example, be enabled for use with various wireless communication networks such as a wireless wide area network (WWAN), a wireless local area network (WLAN), a wireless personal area network (WPAN), and so on. The term “network” and “system” may be used interchangeably herein. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, and so on. A CDMA network may implement one or more radio access technologies (RATs) such as cdma2000, Wideband-CDMA (W-CDMA), to name just a few radio technologies. Here, cdma2000 may include technologies implemented according to IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may include an IEEE 802.11x network, and a WPAN may include a Bluetooth network, an IEEE 802.15x, for example. Wireless communication networks may include so-called next generation technologies (e.g., “4G”), such as, for example, Long Term Evolution (LTE), Advanced LTE, WiMax, Ultra Mobile Broadband (UMB), and/or the like.

As further illustrated in FIG. 1, in certain implementations, the first and second environments may be intended to be within the coverage area of one or more communication networks and/or positioning systems. However, in certain implementations, different environments may fall within the coverage of certain selected communication networks and/or positioning systems. Hence, in FIG. 1, an optional communication network 182-1 is illustrated as possibly being associated more closely with second environment 102-2.

Electronic device 110, as shown in this example, may also include one or more processing units 112, which may be coupled to a memory 122, e.g., via one or more connections 128 (e.g., one or more electrical conductors, optical fibers, etc.).

In this example, processing unit 112 is illustrated as presently performing a positioning function, such as, for example, a navigation function 162. Navigation function 162 may, for example, process information associated with wireless signals from one or more of a communication network, a positioning system, and/or an SPS, and/or other information associated with one or more non-radio sensors 150, to determine an estimated position (e.g., a relative position or location), velocity, and/or other like measurement.

For example, navigation function 162 may track or otherwise process SPS/GNSS signals and provide/record information associated with a route (e.g., location/velocity, etc.) of electronic device 110. In another example, navigation function 162 may track or otherwise process wireless signals transmitted by a positioning system to provide/record information associated with a position/velocity of electronic device 110. As illustrated, navigation function 162 may comprise a trajectory estimation filter 164. By way of non-limiting example, trajectory estimation filter 164 may comprise a Kalman filter, a Particle filter, a Bayes filter, and/or the like, which may be operatively tuned.

As illustrated in this example, memory 122 may comprise different types and/or purposed data storage mechanisms such as, a primary memory 124 and/or a secondary memory 126. Here, for example, primary memory 124 may comprise read only memory, random access memory, and/or the like, which may store information in the form of data representing measured signal parameters 140, etc. Secondary memory 126 may be similar, and/or may include other forms of data storage and/or apparatuses to access such. For example, secondary memory 126 may comprise and/or access a disk and/or disk drive, an optical disc and/or disc drive, a solid state memory, a smart card, etc. Thus, for example an article of manufacture may comprise a computer readable storage medium 132 may be provided with computer implementable instructions 134 (e.g., implementable by processing unit(s) 112, and/or other like circuitry within electronic device 110).

While processing unit 112 and memory 122 are illustrated as being separate in FIG. 1, it should be understood that one or more, or all of the circuit functions illustrated in electronic device 110 may be combined in various manners. For example, at least a portion of the circuitry/capability of processing unit 112 and/or memory 122 may be provided/combined as part of a multimode modem 118 and/or the like. Multimode modem 118 may, for example, be provided as an integrated circuit chip or chip set to service one or more radio(s) and/or associated communication techniques/protocols.

Electronic device 110 may also include one or more input/output interface(s) 130. Here, for example, one or more user interface mechanisms may be provided through which user inputs may be received, and/or one or more output mechanisms may be provided through which information may be presented to a user.

One or more non-radio sensor(s) 150 may be provided in certain implementations. Here, for example, an accelerometer, a gyroscope, a magnetometer, a compass, a barometer, a thermometer and/or the like may be provided which may generate one or more signals representing information that may be useful to one or more functions performed by electronic device 110. For example, such sensors may be used to detect a transition from one environment to another based on detected movement of the device and/or changes in measurable environmental conditions, etc.

In certain example implementations, non-radio sensor(s) 150 may comprise one or more light sensors or the like, and/or a camera (e.g., still or video), which may be used to detect a transition from one environment to another based on changes in lighting, colors, etc. In certain other example implementations, non-radio sensor(s) 150 may comprise a microphone or the like, which may be used to detect a transition from one environment to another based on changes in sounds, etc. In certain other example implementations, non-radio sensor(s) 150 may comprise a temperature sensor or the like, which may be used to detect a transition from one environment to another based on changes in temperatures, etc.

In a particular example, one or more signals associated with one or more non-radio sensors 150 may be used, at least in part, to obtain at least one measured parameter which may be used to determine whether electronic device 110 is at least perceived to be transitioning or to have transitioned from a first environment to a second environment.

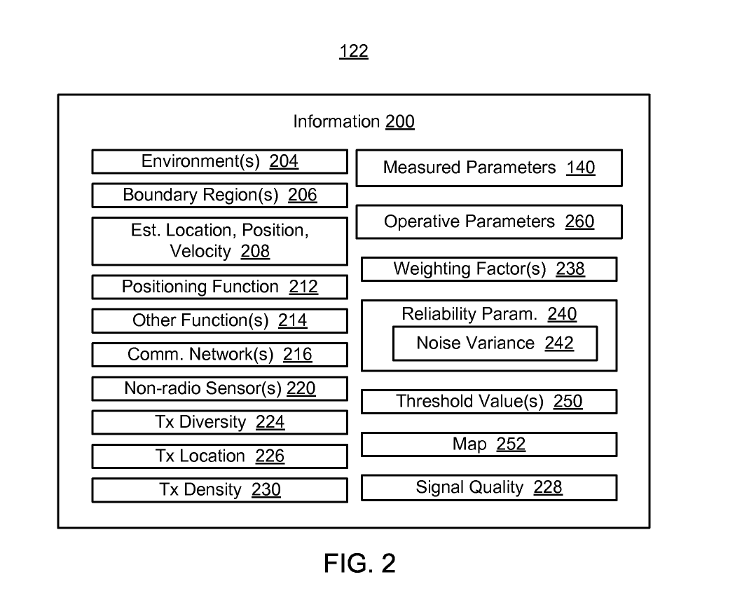

Reference is now made to FIG. 2, which is a block diagram illustrating some example information 200, which may be represented by one or more signals that from time to time be provided to and/or obtained from memory 122, and/or other circuitry in electronic device 110. The purpose and use of such example information are described in greater detail below with regard to an example process 300.

Information 200 may include, for example, information associated with: one or more environment(s) 204, one or more boundary regions 206, an estimated location/position/velocity 208, a positioning function 212, other positioning functions 214, one or more wireless communication networks 216, one or more non-radio sensors 220, transmitter diversity 224 (e.g., number available, types, etc.), transmitter location information 226 (e.g., coordinates, distance, geometry, etc.), signal quality information 228, transmitter density 230, one or more weighting factor(s) 238, one or more perceived signal reliability parameter(s) 240, one or more noise variance parameter(s) 242, one or more measured parameter(s) 140, map information 252, one or more threshold value(s) 250, and/or one or more operative parameters 260.

Information 200 may, for example, comprise information associated with one or more measured parameters 140. For example, a measured parameter 140 may relate to one or more received signals and represent a transition timing measurement, a signal strength measurement, a signal quality measurement, a signal-to-noise ratio measurement, a signal-to-interference ratio measurement, a signal frequency measurement, a code phase measurement, a pilot signal measurement, a RSSI measurement, a RTT measurement, a TDOA measurement, and/or other like signal related measurements.

In certain example implementations, a measured parameter 140 may relate to one or more non-radio sensors 150 and represent an applicable measured condition, etc. For example, a measured parameter 140 may represent information associated with a detected inertial motion, a detected magnetic field, a detected pressure or temperature, a detected light or sound, etc.

Information associated with one or more environment(s) 204 and/or one or more boundary regions 206 may, for example, identify the types, locations, relationships, and/or other like aspects that may be descriptive in a manner to assist in determining whether a transition is occurring or has occurred. Information associated with one or more environment(s) 204 and/or one or more boundary regions 206 may, for example, specify certain preferences with regard to the operation of navigation function 162 or other like positioning capabilities, communication capabilities, map capabilities, and/or the like related to an environment and/or boundary.

Information 208 may provide applicable positioning information as may be used and/or provided by navigation function 162, positioning function 212 and/or other positioning functions 214. For example, information 208 may comprise information associated with one or more previous/current SPS/GNSS determined locations, positions, velocities, routes, etc. For example, information 208 may comprise information associated with one or more previous/current non-SPS/GNSS positioning system determined locations, positions, velocities, routes, etc.

Information 216 may, for example, relate to various signaling and/or other resources associated with one or more wireless communication networks. Information 220 may, for example, relate to various signaling and/or other aspects associated with one or more non-radio sensors 150.

Information 200 may comprise information regarding transmitters that may be used by navigation function 162 and/or other like positioning capabilities. For example, transmitter diversity 224 and/or transmitter density 230 may indicate a number of available, preferred and/or types of transmitters whose transmitted signals may be considered for use in positioning within a region, etc. Transmitter location information 226 may indicate coordinates, distances, etc., relating to such transmitters.

Signal quality information 228 may, for example, indicate one or more metrics associated with one or more signals received from one or more transmitters. In certain example implementations, perceived signal reliability parameter 240 may be based, at least in part, on transmitter diversity 224 transmitter density 230, transmitter location information 226, and/or signal quality information 228. In certain example implementations, perceived signal reliability parameter 240 may be based, at least in part, on the non-wireless signal information represented by said one or more signals associated with at least one of said one or more non-radio sensors 150 (e.g., non-radio sensor information 220) one or more noise variance parameter(s) 242 be determined.

One or more weighting factor(s) 238 may, for example, comprise information relating to a weighting factor associated with positioning information based, at least in part, on perceived signal reliability parameter 240. One or more weighting factor(s) 238 may, for example, comprise information relating to a weighting factor associated with positioning information associated with one or more non-radio sensors 150. In certain example implementations, operation of trajectory estimation filter 164 may be affected by using a pre-defined weighting factor and/or a dynamically defined weighting factor. For example, trajectory estimation filter 164 may be tuned or otherwise adjusted using a pre-defined weighting factor or said dynamically defined weighting factor, which may be selected and/or based, at least in part, on perceived signal reliability parameter 240.

Map information 252 may, for example, comprise all or part of one or more data files that specify and/or otherwise identify certain characteristics and/or aspects with at least a portion of the first and/or second environments. For example, map information 252 may comprise information associated with a layout or other like schematic showing floors, rooms, walls, buildings, staircases, etc. In certain example implementations, map information may comprise a CAD and/or other like data file. In certain example implementations, map information may comprise metadata and/or other like information relating to a region, space, feature, context, use, object, directory, etc., as may be considered in a navigation and/or other like positioning capability, and/or of interest to the user of device 110. In certain example implementations, a navigation and/or other like capability may consider map information 252, which device 110 may obtain from one or more other computing devices. For example, map information 252 may be considered, at least in part, in determining whether electronic device 110 is transitioning or has transitioned from one environment to another and/or affecting an operation of trajectory estimation filter 164.

In certain example instances, map information 252 may comprise all or part of information 200. For example, map information 252 may comprise all or part of environment information 204, boundary region information 206, wireless communication network information 216, transmitter diversity information 224, transmitter location information 226, transmitter density information 230, and/or the like.

One or more threshold value(s) 250 may, for example, be maintained to assist in the various determinations that may be made. For example, threshold values may be used to determine if a measured parameter and/or other parameter, factors, etc., met certain tests.

Operative parameters 260 may, for example, comprise one or more parameters and/or the like associated with navigation function 162, of which at least one or more may be selectively changed and/or otherwise applied in some manner to affect operation of navigation function 162 and/or trajectory estimation filter 164 therein. By way of example, in certain implementations trajectory estimation filter 164 may comprise a Kalman filter, a Particle filter, a Bayes filter, and/or other like smoothing filter, and operation of such filter may be affected by operatively tuning a responsiveness and/or other like characteristic based, at least in part, on a perceived signal reliability parameter (e.g., a noise variance parameter).

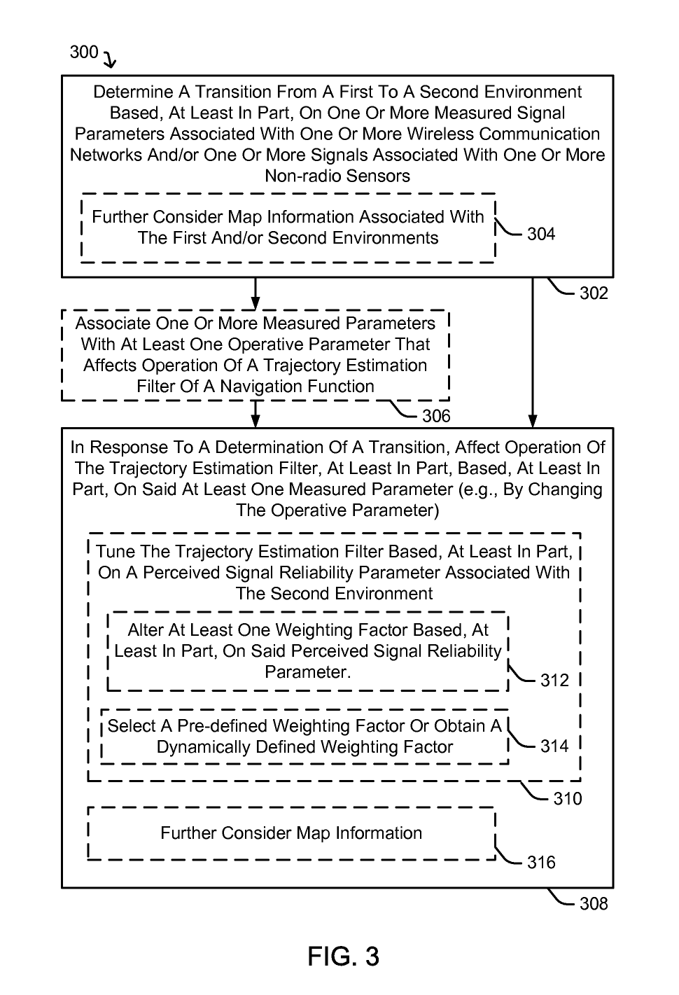

Reference is now made to FIG. 3, which shows a flow-diagram illustrating an example process 300 that may be implemented in and/or with an electronic device 110, such as, the example electronic device 110 in FIG. 1.

At block 302, for example, a determination may be made as to whether an electronic device is transitioning or has transitioned from a first environment to a second environment based, at least in part, on at least one measured parameter 140. Here, for example, measured parameter 140 may be based at least in part on one or more received wireless signals associated with one or more wireless communication networks 182 and/or other wireless signal transmitters. Additionally and/or alternatively, measured parameter 140 may be based, at least in part, on one or more signals associated with one or more non-radio sensors 150.

At (optional) block 304, for example, the decision made at block 302 may further be based, at least in part, on map information 252 (FIG. 2) associated with the first and/or second environments.

At (optional) block 306, for example, one or more measured parameters may be associated with at least one operative parameter 260 (FIG. 2 that affects operation of trajectory estimation filter 164.

At block 308, for example, in response to a determination that electronic device 110 is transitioning or has transitioned from a first environment to a second environment, operation of navigation function 162 and/or trajectory estimation filter 164 may be affected in some manner based, at least in part, on at least one measured parameter 140.

In certain examples, a measured parameter 140 may be associated with and/or otherwise determined using one or more discrete and/or non-discrete, and/or other like functions, models, etc. For example, a function or model may be associated with a transition region and/or other overlapping environments. Thus, in certain instances there is a continuous distribution of settings within such transition regions or the like, and applicable parameters may be determined using an applicable mathematical formula.

In certain example implementations, given (optional) block 306, operation of trajectory estimation filter 164 may be affected, at least in part, by changing an operative parameter 260.

At (optional) block 310, for example, trajectory estimation filter 164 may be tuned based, at least in part, on a perceived signal reliability parameter 240, and/or the like. Here, for example, at (optional) block 312, at least one weighting factor may be altered (e.g., based at least in part on perceived signal reliability parameter 240). At (optional) block 314, for example, a pre-defined weighting factor may be selected and/or a dynamically defined weighting factor determined or otherwise based, at least in part, on perceived signal reliability parameter 240.

In certain example implementations, perceived signal reliability parameter 240 may be based, at least in part, on wireless signal transmitter diversity information 224, wireless signal transmitter density information 230 wireless signal transmitter location information 226, and/or wireless signal quality information 228.

In certain example implementations, perceived signal reliability parameter 240 may be based, at least in part, on non-wireless signal information, e.g., as may be represented by one or more signals associated with one or more non-radio sensors 150.

At (optional) block 316, for example, the affected operation of trajectory estimation filter 164 (at block 308) may further be based, at least in part, on map information 252 (FIG. 2) associated with the first and/or second environments.

By way of further non-limiting example, the above-described apparatuses and processes may be implemented to provide adaptive parameter tuning for indoor trajectory estimation based on signal characteristics of one or more actual and/or perceived environments. As presented herein, such signal characteristics may be identified in some manner in one or more measured parameters 140.

In an example implementation, navigation function related tracking of electronic device 110, such as a mobile phone, a netbook, or any mobile electronic device with wireless radio measurement capabilities and/or with other non-radio sensors may be performed within indoor environments. Many indoor environments tend to have heterogeneous wireless signal characteristics, such as access point density, average signal strength, and other variations leading to differences in measurement reliability. Hence, a smoothing filter, such as some variation of a Kalman filter, a Particle filter, a Bayes filter, and/or the like, may be applied to positioning measurements performed by electronic device 110, in order to better estimate a trajectory and hence an estimated position of a moving target subject to physical constraints.

Such trajectory estimation filters may, for example, incorporate prior (e.g., partial) knowledge of a possible position of a target in the future. For example, an electronic device 110 that was estimated to be at a certain position with a high level of confidence at a given time is likely to be in the vicinity of that position a short time later. However, such a trajectory estimation filter may benefit by using a reasonable model of the mobility of electronic device 110 in order to produce the expected results. For example, a filter that excessively weights the prior estimates may appear to be too slow and/or otherwise unresponsive. Similarly, a filter that overly weights the current measurements may appear to be rugged and/or otherwise jerky.

The method and apparatuses provided herein may be used to avoid such appearances in the operation and/or effectiveness of the navigation function. As described herein, for example, in addition to and/or to otherwise establish an electronic device 110 mobility model, certain other signal characteristics of the environment may be considered which may affect smoothing parameters and/or the like associated with a trajectory estimation filter. Thus, for example, the methods and apparatuses herein may be implemented to allow certain parameters used by the smoothing filter to be selected adaptively as the wireless signal characteristics vary across environments, e.g., as an electronic device 110 is tracked across different indoor environments with differing measured parameters.

One dependent aspect that may be addressed by the example implementations herein may be attributed to imperfections in modeling of certain dynamical systems, e.g., including linearization of an inherently non-linear system as used by certain smoothing filters. Thus, the techniques provided herein may be implemented to adjust one or more filtering parameters in response to detection of variations in pertinent signal characteristics of an environment, e.g., to possibly improve a trajectory estimation process.

Examples of such characteristics that are seen to affect choice(s) of smoothing parameters may include the transmitter (e.g., access point, etc.) density and geometry, availability of round-trip time (RTT) measurements, and other attributes contributing to an overall reliability of the wireless signals. Here, for example, a reliability of a wireless signal may be deduced from a bias in a ranging model (e.g., after trilateration), and/or inferred by considering map information (e.g., for multipath inducing features, etc.).

Transmitter density and geometry, for example, may vary in different indoor environments. Often within the same environment the geometry and the number of usable transmitters may vary substantially, e.g., as an electronic device 110 moves between different parts of a building. In general, in certain environments with low transmitter density and/or with poor transmitter geometry, a smoothing filter may put less weight on individual measurements, as opposed to relatively higher-density environments. In certain instances, full or partial availability of RTT measurements and/or the like may have a similar effect on the combined reliability of a collection of measurements (e.g., in an estimation epoch).

With the techniques presented herein, for example, an adaptive adjustment of such smoothing parameters may be made in response to perceived (detected) changes in the signal characteristics of a newly transitioned to environment. Hence, in certain instances, the resulting trajectory estimation may be improved, e.g., by compensating for imprecision that may exist in a model for a combined reliability of ranging measurements at an estimation epoch.

Reference throughout this specification to “one example”, “an example”, “certain examples”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in certain implementations” or other like phrases in various places throughout this specification are not necessarily all referring to the same feature, example, and/or limitation. Furthermore, the particular features, structures, or characteristics may be combined in one or more examples and/or features.

The terms, “and”, “or”, and “and/or” as used herein may include a variety of meanings that also are expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe a plurality or some other combination of features, structures or characteristics. Though, it should be noted that this is merely an illustrative example and claimed subject matter is not limited to this example.

The methodologies described herein may be implemented by various means depending upon applications according to particular features and/or examples. For example, such methodologies may be implemented in hardware, firmware, and/or combinations thereof, along with software. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter.

Some portions of the preceding detailed description have been presented in terms of algorithms or symbolic representations of operations on binary digital electronic signals stored within a memory of a specific apparatus or special purpose computing device or platform. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated as electronic signals representing information. It has proven convenient at times, principally for reasons of common usage, to refer to such signals as bits, data, values, elements, symbols, characters, terms, numbers, numerals, information, or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining”, “establishing”, “obtaining”, “generating”, and/or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein.

Therefore, it is intended that claimed subject matter not be limited to the particular examples disclosed, but that such claimed subject matter may also include all aspects falling within the scope of appended claims, and equivalents thereof.

What is claimed is:

1. A method comprising: with an electronic device:
determining that said electronic device is transitioning or has transitioned from a first environment to a second environment based, at least in part, on at least one measured parameter, said at least one measured parameter being based, at least in part, on at least one of:
one or more received wireless signals associated with one or more wireless signal transmitters, and/or
one or more signals associated with one or more non-radio sensors; and
in response to a determination that said electronic device is transitioning or has transitioned from said first environment to said second environment, affecting an operation of a trajectory estimation filter of a navigation function based, at least in part, on said at least one measured parameter.

2. The method as recited in claim 1, further comprising: with said electronic device:
associating said at least one measured parameter with at least one operative parameter that affects operation of said trajectory estimation filter and affecting said operation of said trajectory estimation filter, at least in part, by changing said at least one operative parameter.

3. The method as recited in claim 1, wherein affecting said operation of said trajectory estimation filter further comprises:
selectively tuning said trajectory estimation filter based, at least in part, on a perceived signal reliability parameter associated with said second environment.

4. The method as recited in claim 1, wherein affecting said operation of said trajectory estimation filter further comprises:
selectively altering at least one weighting factor associated with positioning information based, at least in part, on said perceived signal reliability parameter.

5. The method as recited in claim 4, wherein said at least one weighting factor is associated with positioning information associated with said one or more non-radio sensors.

6. The method as recited in claim 3, wherein said perceived signal reliability parameter is based, at least in part, on at least one of: wireless signal transmitter diversity information; wireless signal transmitter density information; wireless signal transmitter location information; and/or wireless signal quality information.

7. The method as recited in claim 3, wherein said perceived signal reliability parameter is based, at least in part, on non-wireless signal information represented by said one or more signals associated with at least one of said one or more non-radio sensors.

8. The method as recited in claim 1, wherein said trajectory estimation filter comprises at least one of a Kalman filter, a Particle filter, and/or a Bayes filter.

9. The method as recited in claim 3, wherein said trajectory estimation filter comprises at least one of a Kalman filter, a Particle filter, and/or a Bayes filter, and said perceived signal reliability parameter comprises a noise variance parameter, and further comprising: with said electronic device:
affecting said operation of said trajectory estimation filter by operatively tuning a responsiveness of at least one of said Kalman filter, said Particle filter, and/or said Bayes filter based, at least in part, on said noise variance parameter.

10. The method as recited in claim 3, further comprising: with said electronic device:
affecting said operation of said trajectory estimation filter by using a pre-defined weighting factor or a dynamically defined weighting factor in said trajectory estimation filter, wherein said pre-defined weighting factor or said dynamically defined weighting factor is selected and/or based, at least in part, on said perceived signal reliability parameter.

11. The method as recited in claim 1, further comprising: with said electronic device:
accessing one or more signals representing map information associated with at least a portion of at least one of said first and/or second environments; and
based at least in part on said map information, determining that said electronic device is transitioning or has transitioned from said first environment to said second environment, and/or affecting said operation of said trajectory estimation filter.

12. The method as recited in claim 1, wherein said first and second environments are associated different indoor spaces within a common physical structure.

13. An apparatus for use in an electronic device, the apparatus comprising:
at least one of: one or more radio receivers to receive one or more wireless signals associated with one or more wireless signal transmitters, and/or one or more non-radio sensors; and
at least one processing unit to:
perform a navigation function using a trajectory estimation filter;
determine that said electronic device is transitioning or has transitioned from a first environment to a second environment based, at least in part, on at least one measured parameter, said at least one measured parameter being based, at least in part, on at least one of:
one or more received wireless signals associated with said one or more wireless signal transmitters, and/or
one or more signals associated with said one or more non-radio sensors; and
in response to a determination that said electronic device is transitioning or has transitioned from said first environment to said second environment, affect an operation of said trajectory estimation filter based, at least in part, on said at least one measured parameter.

14. The apparatus as recited in claim 12, said at least one processing unit to:
associate said at least one measured parameter with at least one operative parameter that affects operation of said trajectory estimation filter and affect said operation of said trajectory estimation filter, at least in part, by changing said at least one operative parameter.

15. The apparatus as recited in claim 13, said at least one processing unit to:
selectively tune said trajectory estimation filter based, at least in part, on a perceived signal reliability parameter associated with said second environment.

16. The apparatus as recited in claim 13, said at least one processing unit to:
selectively alter at least one weighting factor associated with positioning information based, at least in part, on said perceived signal reliability parameter.

17. The apparatus as recited in claim 16, wherein said at least one weighting factor is associated with positioning information associated with said one or more non-radio sensors.

18. The apparatus as recited in claim 15, wherein said perceived signal reliability parameter is based, at least in part, on at least one of: wireless signal transmitter diversity information; wireless signal transmitter density information; wireless signal transmitter location information; and/or wireless signal quality information.

19. The apparatus as recited in claim 15, wherein said perceived signal reliability parameter is based, at least in part, on non-wireless signal information associated with at least one of said one or more non-radio sensors.

20. The apparatus as recited in claim 13, wherein said trajectory estimation filter comprises at least one of a Kalman filter, a Particle filter, and/or a Bayes filter.

21. The apparatus as recited in claim 15, said trajectory estimation filter comprising at least one of a Kalman filter, a Particle filter, and/or a Bayes filter, said perceived signal reliability parameter comprising a noise variance parameter, and said at least one processing unit to:
affect said operation of said trajectory estimation filter by operatively tuning a responsiveness of at least one of said Kalman filter, said Particle filter, and/or said Bayes filter based, at least in part, on said noise variance parameter.

22. The apparatus as recited in claim 15, said at least one processing unit to:
affect said operation of said trajectory estimation filter by using a pre-defined weighting factor or a dynamically defined weighting factor in said trajectory estimation filter, wherein said pre-defined weighting factor or said dynamically defined weighting factor is selected and/or based, at least in part, on said perceived signal reliability parameter.

23. The apparatus as recited in claim 13, said at least one processing unit to:
obtain map information associated with at least at portion of at least one of said first and/or second environments; and
based at least in part on said map information determine that said electronic device is transitioning or has transitioned from said first environment to said second environment, and/or affect said operation of said trajectory estimation filter.

24. The apparatus as recited in claim 13, wherein said first and second environments are associated different indoor spaces within a common physical structure.

25. An article comprising:
a computer readable storage medium having stored thereon computer implementable instructions executable by one or more processing units of an electronic device to:
determine that said electronic device is transitioning or has transitioned from a first environment to a second environment based, at least in part, on at least one measured parameter, said at least one measured parameter being based, at least in part, on at least one of:
one or more received wireless signals associated with one or more wireless signal transmitters, and/or
one or more signals associated with one or more non-radio sensors; and
in response to a determination that said electronic device is transitioning or has transitioned from said first environment to said second environment, affect an operation of a trajectory estimation filter of a navigation function based, at least in part, on said at least one measured parameter.

26. The article as recited in claim 25, wherein said computer implementable instructions are further executable by said one or more processing units to:
associate said at least one measured parameter with at least one operative parameter that affects operation of said trajectory estimation filter and affect said operation of said trajectory estimation filter, at least in part, by changing said at least one operative parameter.

27. The article as recited in claim 25, wherein said computer implementable instructions are further executable by said one or more processing units to:
selectively tune said trajectory estimation filter based, at least in part, on a perceived signal reliability parameter associated with said second environment.

28. The article as recited in claim 25, wherein said computer implementable instructions are further executable by said one or more processing units to:
selectively alter at least one weighting factor associated with positioning information based, at least in part, on said perceived signal reliability parameter.

29. The article as recited in claim 28, wherein said at least one weighting factor is associated with positioning information associated with said one or more non-radio sensors.

30. The article as recited in claim 27, wherein said perceived signal reliability parameter is based, at least in part, on at least one of: wireless signal transmitter diversity information; wireless signal transmitter density information; wireless signal transmitter location information; and/or wireless signal quality information.

31. The article as recited in claim 27, wherein said perceived signal reliability parameter is based, at least in part, on non-wireless signal information associated with at least one of said one or more non-radio sensors.

32. The article as recited in claim 25, wherein said trajectory estimation filter comprises at least one of a Kalman filter, a Particle filter, and/or a Bayes filter.

33. The article as recited in claim 27, wherein said trajectory estimation filter comprises at least one of a Kalman filter, a Particle filter, and/or a Bayes filter, and said perceived signal reliability parameter comprises a noise variance parameter, and said computer implementable instructions are further executable by said one or more processing units to:
affect said operation of said trajectory estimation filter by operatively tuning a responsiveness of at least one of said Kalman filter, said Particle filter, and/or said Bayes filter based, at least in part, on said noise variance parameter.

34. The article as recited in claim 27, wherein said computer implementable instructions are further executable by said one or more processing units to:
affect said operation of said trajectory estimation filter by using a pre-defined weighting factor or a dynamically defined weighting factor in said trajectory estimation filter, wherein said pre-defined weighting factor or said dynamically defined weighting factor is selected and/or based, at least in part, on said perceived signal reliability parameter.

35. The article as recited in claim 25, wherein said computer implementable instructions are further executable by said one or more processing units to:
obtain map information associated with at least at portion of at least one of said first and/or second environments; and
based at least in part on said map information determine that said electronic device is transitioning or has transitioned from said first environment to said second environment, and/or affect said operation of said trajectory estimation filter.

36. The article as recited in claim 25, wherein said first and second environments are associated different indoor spaces within a common physical structure.

37. An apparatus for use in an electronic device, the apparatus comprising:
means for providing a navigation function that uses a trajectory estimation filter;
means for determining that said electronic device is transitioning or has transitioned from a first environment to a second environment based, at least in part, on at least one measured parameter, said at least one measured parameter being based, at least in part, on at least one of:
one or more received wireless signals associated with one or more wireless signal transmitters, and/or
one or more signals associated with one or more non-radio sensors; and
means for affecting an operation of said trajectory estimation filter based, at least in part, on said at least one measured parameter, in response to a determination that said electronic device is transitioning or has transitioned from said first environment to said second environment.

38. The apparatus as recited in claim 34, further comprising:
means for associating said at least one measured parameter with at least one operative parameter that affects operation of said trajectory estimation filter; and
means for changing said at least one operative parameter to affect said operation of said trajectory estimation filter.

39. The apparatus as recited in claim 37, further comprising:
means for selectively tuning said trajectory estimation filter based, at least in part, on a perceived signal reliability parameter associated with said second environment.

40. The apparatus as recited in claim 37, further comprising:
means for selectively altering at least one weighting factor associated with positioning information based, at least in part, on said perceived signal reliability parameter.

41. The apparatus as recited in claim 40, wherein said at least one weighting factor is associated with positioning information associated with said one or more non-radio sensors.

42. The apparatus as recited in claim 39, wherein said perceived signal reliability parameter is based, at least in part, on at least one of: wireless signal transmitter diversity information; wireless signal transmitter density information; wireless signal transmitter location information; and/or wireless signal quality information.

43. The apparatus as recited in claim 39, wherein said perceived signal reliability parameter is based, at least in part, on non-wireless signal information associated with at least one of said one or more non-radio sensors.

44. The apparatus as recited in claim 37, wherein said trajectory estimation filter comprises at least one of a Kalman filter, a Particle filter, and/or a Bayes filter.

45. The apparatus as recited in claim 39, wherein said trajectory estimation filter comprises at least one of a Kalman filter, a Particle filter, and/or a Bayes filter, said perceived signal reliability parameter comprises a noise variance parameter, and said means for affecting said operation of said trajectory estimation filter operatively tunes a responsiveness of at least one of said Kalman filter, said Particle filter, and/or said Bayes filter based, at least in part, on said noise variance parameter.

46. The apparatus as recited in claim 39, wherein said means for affecting said operation of said trajectory estimation filter uses, at least in part, a pre-defined weighting factor or a dynamically defined weighting factor to affect said trajectory estimation filter, wherein said pre-defined weighting factor or said dynamically defined weighting factor is selected and/or based, at least in part, on said perceived signal reliability parameter.

47. The apparatus as recited in claim 37, further comprising:
means for obtaining map information associated with at least at portion of at least one of said first and/or second environments; and
at least one of:
means for determining that said electronic device is transitioning or has transitioned from said first environment to said second environment based at least in part on said map information, and/or
means for affecting said operation of said trajectory estimation filter based at least in part on said map information.

48. The apparatus as recited in claim 37, wherein said first and second environments are associated different indoor spaces within a common physical structure.
